(19) United States
(12) Patent Application Publication
(10) Pub. No.: US 2008/0186019 A1
(43) Pub. Date: Aug. 7, 2008

(54) Arrangement Comprising A Magnetic Field Sensor

(75) Inventor: Michael Hinz, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/630,587

(22) PCT Filed: Jun. 16, 2005
(86) PCT No.: PCT/IB2005/051989

§ 371 Date: Nov. 7, 2007

(30) Foreign Application Priority Data
Jun. 25, 2004 (EP) 04102955.4

(51) Int. Cl. G01B 7/00

(52) U.S. Cl. 324/207.21; 324/207.13

(57) ABSTRACT

In an arrangement comprising a magnetic field sensor which is effectively connected to a magnetic encoder which is arranged such that it can move with respect to the sensor and comprises magnetic poles with alternating polarity, wherein the sensor consists of at least two half-bridges which are in each case formed by two magnetoelectric elements, the electrical properties of which depend on the magnetic field strength, it is provided that the elements of each half-bridge have resistance/field strength characteristics which run in opposite directions and are arranged such that they are in phase with respect to the magnetic field, and that the spacing between the half-bridges corresponds to part of the pole pitch of the magnetic encoder.

The invention relates to an arrangement comprising a magnetic field sensor which is effectively connected to a magnetic encoder which is arranged such that it can move with respect to the sensor and comprises magnetic poles with alternating polarity, wherein the sensor consists of at least two half-bridges which are in each case formed by two magnetoelectric elements, the electrical properties of which depend on the magnetic field strength.

Arrangements comprising magnetic field sensors are used for a wide range of purposes, in particular in rotary magnetic encoders for measuring rotational speeds, for detecting the direction of rotation and for measuring the angular position, and in linear magnetic encoders for measuring position and speed. The encoder has an alternatingly magnetized layer. During the relative movement of the encoder, the sensor generates periodic, for example sinusoidal, output signals which without any further measures in each case have a signal period over an angle of 360°. This corresponds to a North/South pole pair of the magnetic layer and thus to a pole pitch λ(=360°).

Such a sensor is described for example in U.S. Pat. No. 6,246,233 B1, wherein measures are taken to increase the resolution (pulses per pole pitch of the encoder). In this document, four magnetoresistive resistors are arranged at a spacing of three-eighths of the pole pitch, in each case forming a half-bridge, the output signals of which are phase-shifted. By forming square-wave signals and carrying out logical linking, pulses having double said frequency are then produced. In the known arrangement, however, it is also possible for more than two half-bridges to be used. On account of the predefined spacing, the known sensor arrangement is quite large, and this leads to considerable costs particularly in the case of mass production using integrated technologies.

It is an object of the invention to reduce the dimensions of the mechanical components while retaining as high a resolution of the sensor arrangement as possible.

This object is achieved by the arrangement according to the invention in that the elements of each half-bridge have resistance/field strength characteristics which run in opposite directions and are arranged such that they are in phase with respect to the magnetic field, and in that the spacing between the half-bridges corresponds to part of the pole pitch of the magnetic encoder.

Preferably, in the arrangement according to the invention, it is provided that the spacing between the half-bridges corresponds to one quarter of the pole pitch of the magnetic encoder. However, it is also possible that the spacing between the half-bridges is not equal to one quarter of the pole pitch of the magnetic encoder, and that at least one of the output signals of the half-bridges is subjected to phase correction.

When using two half-bridges, by virtue of the invention only a spacing of the two half-bridges of part of the pole pitch is required for a suitably small size of the sensor, whereas the known arrangement in this case is more than one pole pitch long.

Magnetoelectric elements with resistance/field strength characteristics which run in opposite directions can be obtained. Preferably, in the invention it is provided that the magnetoelectric elements are magnetoresistive elements with barber poles, wherein the orientation of the barber poles is opposed in such a way that the resistance/field strength characteristics are opposed, in particular in such a way that the orientation of the barber poles is offset by 90° with respect to one another.

Magnetoresistive elements with barber poles are commercially available and are described for example in Philips “Data Handbook SC17 2001, Semiconductor Sensors”, pages 33, 39.

A simple multiplication of the frequency of the output signals of the at least two half-bridges is obtained in one advantageous embodiment in that the output signals of the at least two half-bridges are converted into binary signals, and in that the binary signals are logically linked. This may preferably take place using an exclusive-OR gate.

According to another advantageous embodiment, another possibility for increasing the resolution is possible in that the output signals of the at least two half-bridges are converted into a signal which changes linearly with the movement of the encoder by applying an inverse trigonometric function.

The invention will be further described with reference to examples of embodiments shown in the drawings to which, however, the invention is not restricted.

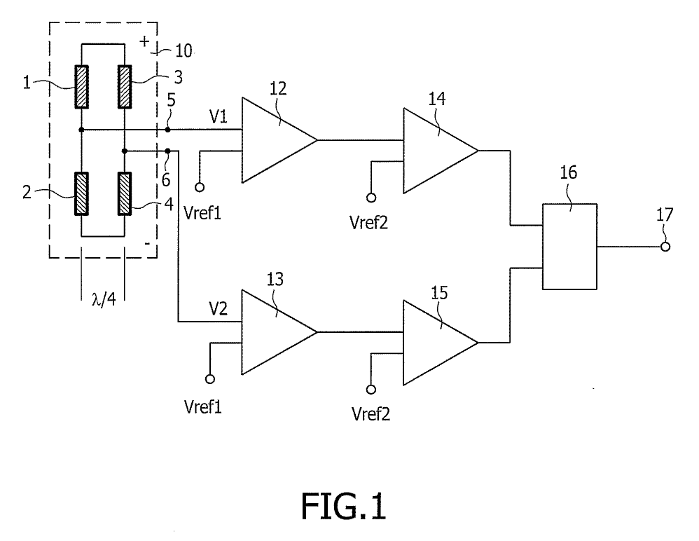

FIG. 1 shows two half-bridges consisting of magnetoresistive resistors, which are arranged at a spacing of ¼.

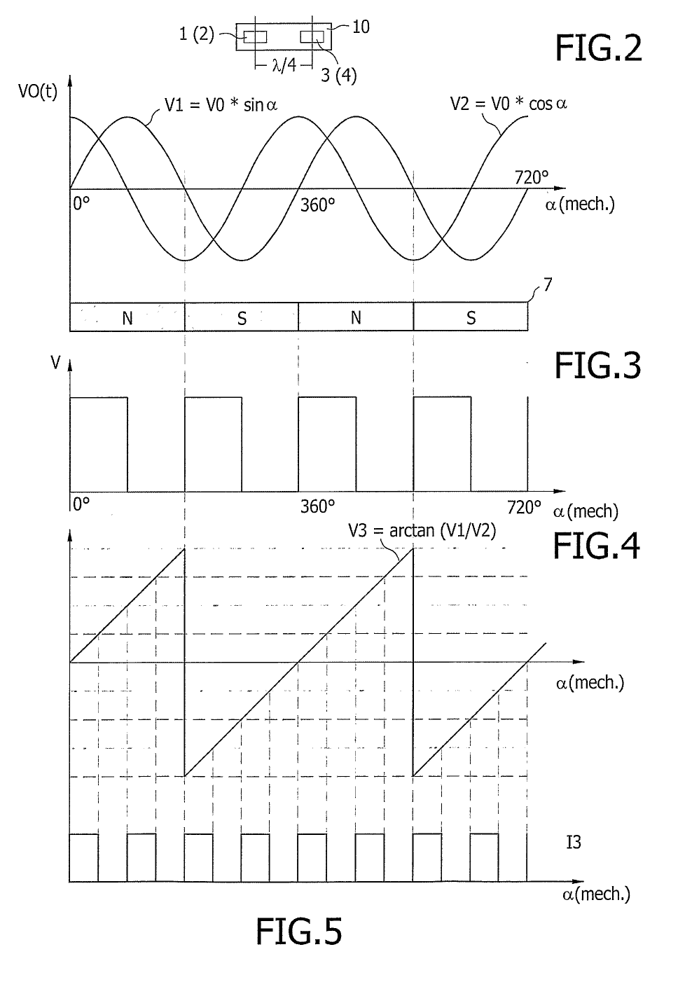

FIG. 2 shows the sensor with two half-bridges in side view.

FIG. 3 shows the curve of the output signals of the half-bridges shown in FIG. 1.

FIG. 4 shows the curve of output pulses of the arrangement shown in FIG. 1.

FIG. 5 shows one example of a different way of generating output pulses.

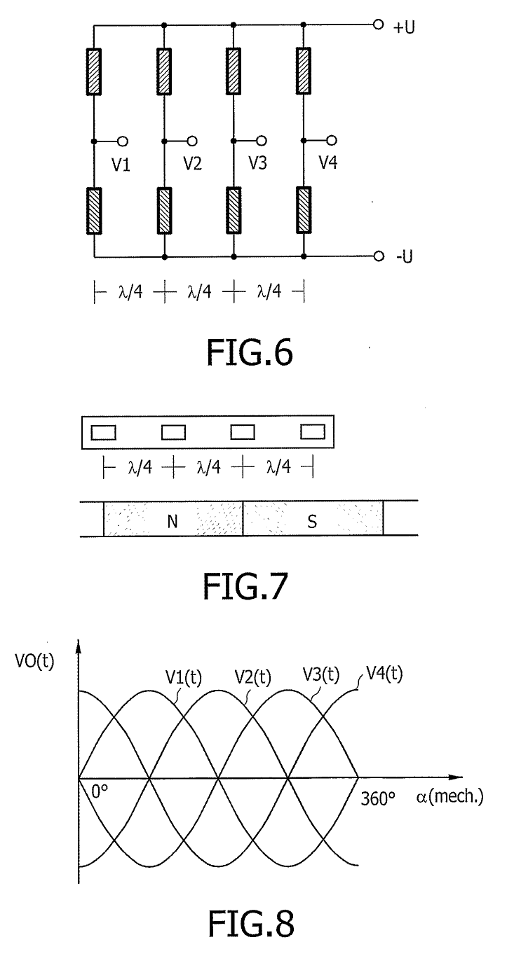

FIG. 6 shows one example of a sensor with four half-bridges.

FIG. 7 shows the same sensor and its cooperation with a magnetic encoder.

FIG. 8 shows the output signals of the sensor shown in FIGS. 6 and 7.

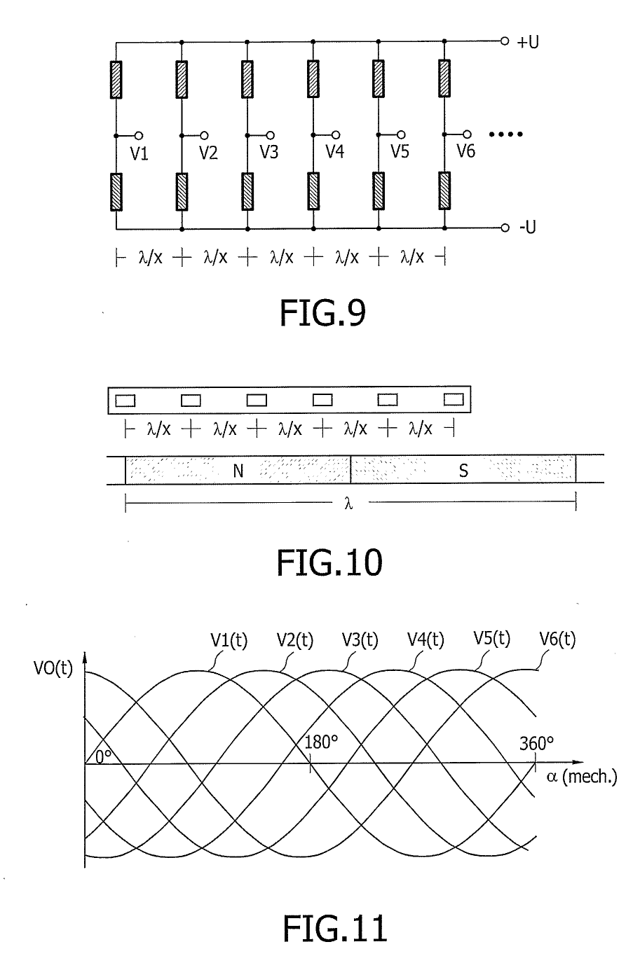

FIG. 9 shows a sensor with x half-bridges which are arranged at a spacing other than λ/4.

FIG. 10 shows the same sensor cooperating with a magnetic encoder.

FIG. 11 shows the output signals of the encoder shown in FIGS. 9 and 10.

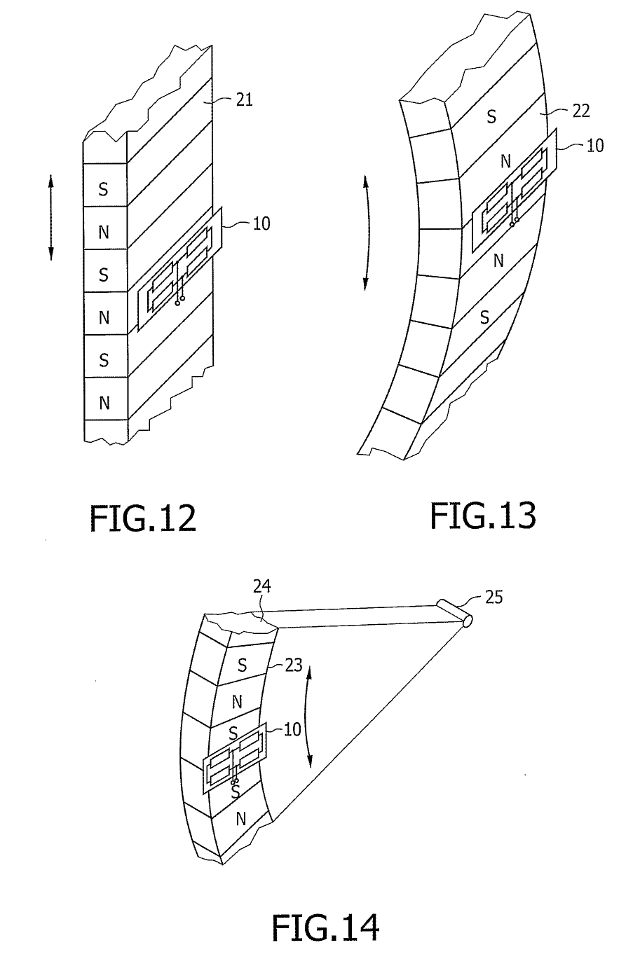

FIG. 12 shows one application example of a magnetoresistive sensor for position measurement on a linear encoder.

FIG. 13 shows one application example for measuring rotational speeds at the circumference of a rotary encoder.

FIG. 14 shows one application example for measuring rotational speeds at the end face of a rotary encoder.

### DESCRIPTION OF PREFERRED EMBODIMENTS

FIG. 1 shows two half-bridges with magnetoresistive resistors 1, 2, 3, 4, wherein the resistors of each of the half-bridges 1, 2; 3, 4 are provided with barber poles of different orientation, as shown in FIGS. 1 and 2 by the different direction of the hatching. The outputs 5, 6 of the half-bridges carry voltages V1 and V2, respectively, which are sinusoidal and are phase-shifted by a quarter of the pole pitch of the encoder 7 shown in part in FIG. 3.

The output signals V1 and V2 of the half-bridges are each fed to an amplifier 12, 13 where they are compared with a reference voltage Vref1. The difference passes in each case to a comparator 14, 15 where it is converted into binary signals by comparison with a further reference voltage Vref2. These binary signals are linked to one another at 16, so that the signal Vout is produced at an output 17, which signal Vout is shown in FIG. 4 and has a wavelength that is half the size of the pole pitch λ. FIG. 2 shows the sensor with two half-bridges in side view.

FIG. 5 shows another possibility for deriving square-wave pulses from the sinusoidal voltages, wherein the square-wave pulses have a higher frequency than those shown in FIG. 4. For this purpose, a voltage V3=arctan(V1/V2) which changes linearly with the angle α is derived from V1 and V2, for example using a Cordic algorithm. The pulse signal I3 shown in FIG. 5 is then produced by means of a number of comparators or analog/digital converters, wherein in the example shown in FIG. 5 the number of pulses over a pole pitch can be increased by a factor of 2 compared to FIG. 4. The number of pulses is thus determined by the number of resolution steps of the comparator unit.

FIG. 6 shows a sensor with four half-bridges which are each arranged at a spacing of λ/4, and its cooperation with a magnetic encoder is shown in FIG. 7. The output signals are shown in FIG. 8 and may advantageously be linked to form a digital signal with a high angular resolution.

The invention is not restricted to spacings of λ/4 of the individual half-bridges of the sensors. Other spacings x may also be selected, as shown for a sensor with x half-bridges in FIGS. 9 and 10. On account of the phase shift other than λ/4 in the output signals shown in FIG. 11, evaluation thereof requires further measures in order to form a digital signal which represents an integer multiple of the pole pitch. Such measures include for example sum and difference formation.

FIG. 12 shows a sensor 10 which lies opposite a linear magnetic encoder 21 which can move in the direction of the arrow.

FIG. 13 shows the same sensor at the circumference of a rotary encoder 22. The output voltages of the half-bridges V1 and V2 are evaluated in the same way as in the example of embodiment shown in FIG. 1—as is the case also in the example of embodiment shown in FIG. 14 which shows a sensor 10 at the end face 23 of a rotary magnetic encoder 24.

1. An arrangement comprising a magnetic field sensor which is effectively connected to a magnetic encoder which is arranged such that it can move with respect to the sensor and comprises magnetic poles with alternating polarity, wherein the sensor consists of at least two half-bridges which are in each case formed by two magnetoelectric elements the electrical properties of which depend on the magnetic field strength, characterized in that the elements of each half-bridge have resistance/field strength characteristics which run in opposite directions and are arranged such that they are in phase with respect to the magnetic field, and in that the spacing between the half-bridges corresponds to part of the pole pitch of the magnetic encoder

2. An arrangement as claimed in claim 1, characterized in that the spacing between the half-bridges corresponds to one quarter of the pole pitch of the magnetic encoder

3. An arrangement as claimed in claim 1, characterized in that the spacing between the half-bridges is not equal to one quarter of the pole pitch of the magnetic encoder, and in that at least one of the output signals of the half-bridges is subjected to phase correction.

4. An arrangement as claimed in claim 1, characterized in that the magnetoelectric elements are magnetoresistive elements with barber poles, wherein the orientation of the barber poles is opposed in such a way that the resistance/field strength characteristics are opposed.

5. An arrangement as claimed in claim 4, characterized in that the orientation of the barber poles is offset by 90° with respect to one another.

6. An arrangement as claimed in claim 1, characterized in that the output signals of the at least two half-bridges are converted into binary signals, and in that the binary signals are logically linked.

7. An arrangement as claimed in claim 1, characterized in that the output signals of the at least two half-bridges are converted into a signal which changes linearly with the movement of the encoder by applying an inverse trigonometric function.
